(19) United States
(12) Patent Application Publication
(10) Pub. No.: US 2019/0108857 A1
(43) Pub. Date: Apr. 11, 2019

(54) PLAYLIST MANAGING SYSTEM

(71) Applicant: Onkyo Corporation, Osaka (JP)

(72) Inventors: Honami HIRATA, Osaka (JP); Nobuya TACHIMORI, Osaka (JP); Tokinori TADA, Osaka (JP); Takahiro SUZUKI, Osaka (JP)

(21) Appl. No.: 16/155,288

(22) Filed: Oct. 9, 2018

(30) Foreign Application Priority Data
Oct. 10, 2017 (JP) 2017-196816

(51) Int. Cl. G11B 27/031; G11B 27/10; G11B 27/17; G06F 17/30

(52) U.S. Cl. CPC G11B 27/031; G11B 27/102; G11B 2220/61; G06F 17/30772; G11B 27/17

(57) ABSTRACT

An electronic device comprising: an internal memory which has a folder for back-up; and a first controller, wherein the first controller outputs playlists of an application to the folder for back-up of the internal memory as a playlist file when a playlist managing device is connected to the electronic device.

### CROSS-REFERENCE TO RELATED APPLICATIONS

This application claims priority to Japanese Application No. 2017-196816, filed Oct. 10, 2017, the entire contents of which are incorporated herein by reference.

### FIELD

The present disclosure relates to a playlist managing system which manages playlists.

### BACKGROUND

There is a case where playlists which are made by a music reproduction application of a portable digital audio player (DAP) and are in application database (DB) can be automatically backed up (saved) to a PC and the playlists which are backed up to the PC can be restored (reconstructed) to the DAP (for example, see JP 2005-533333 T.) at the time of connecting with a personal computer (PC). In this case, the above function is implemented by a dedicated protocol (for example, iPhone (registered trademark) and iTunes (registered trademark).).

However, in several kinds of devices which perform communication with separate existing protocols, when uniform operation is performed, the above method cannot be applied.

### SUMMARY

According to one aspect of the disclosure, there is provided an electronic device comprising: an internal memory which has a folder for back-up; and a first controller, wherein the first controller outputs playlists of an application to the folder for back-up of the internal memory as a playlist file when a playlist managing device is connected to the electronic device.

### BRIEF DESCRIPTION OF THE DRAWINGS

FIG. 1 is a block diagram illustrating a constitution of a content managing system according to an embodiment of the present disclosure.

FIG. 2 is a diagram illustrating processing operation of the content managing system in a case where playlists which are stored in a DAP are backed up to a PC.

FIG. 3 illustrates a storage name replacement table.

FIG. 4 is a diagram illustrating processing operation of the content managing system in a case where the playlists which are stored in the PC are restored to the DAP.

### DETAILED DESCRIPTION OF THE PREFERRED EMBODIMENTS

An objective of the present disclosure is to be able to manage playlists without using a dedicated protocol.

(Content Managing System)

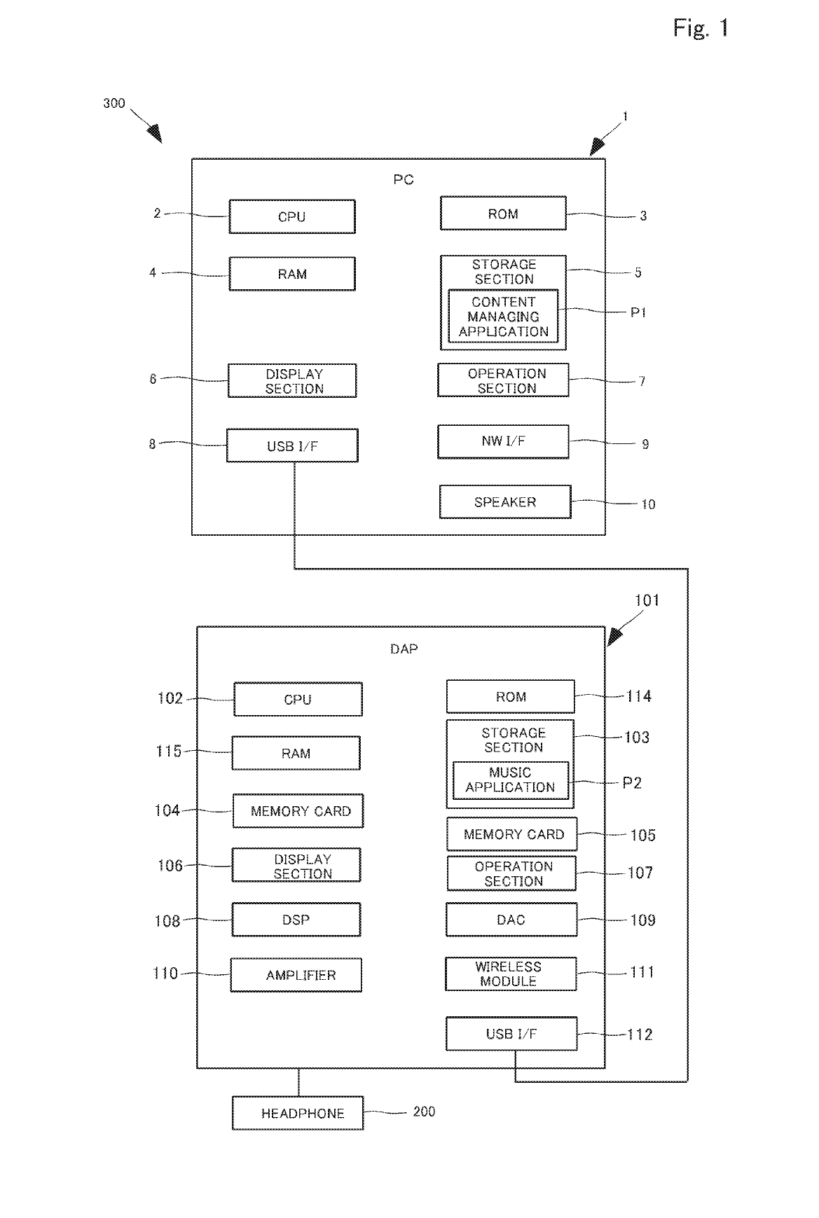

An embodiment of the present disclosure is described below. FIG. 1 is a block diagram illustrating a constitution of a content managing system 300 according to the present embodiment. The content managing system 300 manages contents which are stored in a digital audio player (hereinafter, referred to as “DAP”) 101 and functions as a playlist managing system which manages playlists. The content managing system 300 includes a personal computer (hereinafter, referred to as “PC”) 1 which functions as a content managing device (a playlist managing device) and the DAP 101.

(PC)

The PC 1 functions as the content managing device which manages contents when a content managing application P1 which is stored in a storage section 5 is executed. The PC 1 includes a CPU (Central Processing Unit) 2, a ROM (Read Only Memory) 3, a RAM (Random Access Memory) 4, the storage section 5, a display section 6, an operation section 7, a USB interface (hereinafter, referred to as “USB I/F”) 8, and a network interface (hereinafter, referred to as “NW I/F”) 9, and a speaker 10. The content managing program P1 may be stored in the storage section 5 of the PC 1 when the PC1 is shipped from a factory, and may be downloaded from a not shown server via the NW I/F 9 which is described below and be stored in the storage section 5 of the PC 1.

The CPU 2 (second controller) controls respective sections composing the PC 1 according to a control program, an OS (Operating System) program and application programs including the content managing application P1.

The ROM 3 stores the control program. The RAM 4 functions as a main memory of the CPU 2. The storage section 5 (memory) is an HDD (Hard Disc Drive) which stores programs such as the application programs including the OS programs and the content managing application P1 and contents such as music, still images, and moving images. Not limited to illustrated constitution, the storage section 5 may be an SSD (Solid State Drive) or the like.

The display section 6 displays various images (including still images and moving images), and is, for example, a liquid crystal display. The operation section 7 is composed of a keyboard, a mouse and so on and is for performing various settings, sending instruction of contents and so on. The user can execute the content managing application P1, perform sending instruction of contents to the DAP 101 and so on via the operation section 7. The USB I/F 8 is an interface for performing communication with the DAP 101 according to USB standard. The PC 1 can perform communication with the DAP 101 via the USB I/F 8. The NW I/F 9 is an interface which is for connecting to an Internet via a not shown network. The PC 1 can perform communication and the like to another terminal via the NW I/F 9. The speaker 10 outputs various audio such as music based on an audio signal which is output from the CPU 2.

(DAP)

The DAP 101 (electronic device) functions as a music reproduction device which reproduces music (contents) when a music application P2 which is stored in a storage section 103 is executed. The DAP 101 outputs analog audio data to a headphone 200. The headphone 200 outputs audio outside based on the analog audio data. The DAP 101 includes a CPU 102, a ROM 114, a RAM 115, the storage section 103, memory cards 104 and 105, a display section 106, an operation section 107, a DSP (Digital Signal Processor) 108, a D/A converter (hereinafter, referred to as “DAC”) 109, an amplifier 110, a wireless module 111, and a USB interface (hereinafter, referred to as “USB I/F”) 112.

The CPU 102 (first controller) controls respective sections composing the DAP 101 according to a control program, an OS program and application programs including the music application P2. The ROM 114 stores the control program. The RAM 115 functions as a main memory of the CPU 102. The storage section 103 (internal memory, storage) is a flash memory which stores programs such as the OS program and application programs, and various data such as contents. The storage section 103 is an internal memory. Not limited to illustrated constitution, the storage section 103 may be an HDD (Hard Disk Drive) or the like.

Each of the memory cards 104 and 105 (storage) stores the contents. For example, each of the memory cards 104 and 105 is microSD card. Each of the memory cards 104 and 105 is an external storage. The display section 106 displays various images (including still images and moving images) and is composed of a liquid crystal panel. The operation section 107 includes operation keys for performing various settings and a touch panel which is linked with the display section 106. The user can perform various character input, settings and so on via the operation section 107. Further, the user can make playlists which designate reproduction order of contents via the operation section 107.

The DSP 108 performs signal processing such as equalizer processing to digital audio data (contents). The DAC 109 D/A-converts the digital audio data to the analog audio data. The amplifier 110 amplifies the analog audio data which is D/A-converted by the DAC 109 and outputs the amplified analog audio data to the headphone 200. The wireless module 111 (network interface) is for performing wireless communication according to Bluetooth (registered trademark) standard and Wi-Fi standard. The DAP 101 can communicate with an external server via the wireless module 112. The USB I/F 113 is for performing communication according to USB standard. The DAP 101 can communicate with the PC 1 via the USB I/F 113.

The PC 1 manages the contents which are stored in the storage section 103 and the memory cards 104 and 105. The PC 1 and the DAP 101 are connected by a USB cable.

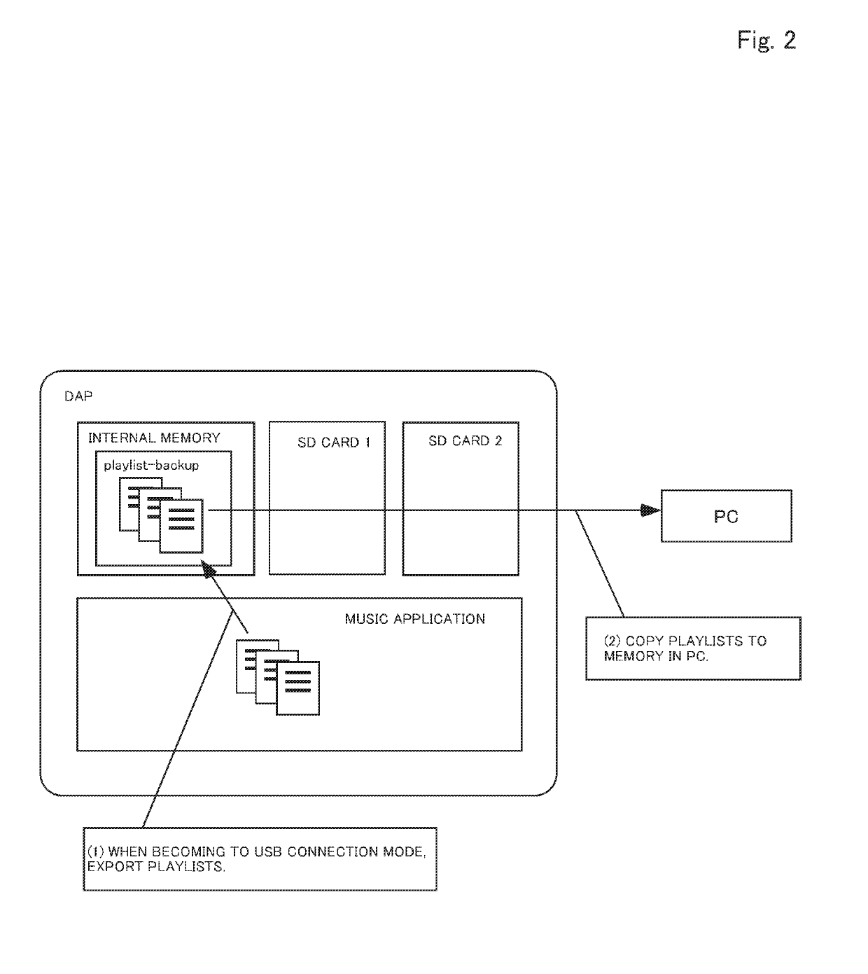

Next, processing operation of the content managing system 300 in a case where the playlists which are stored in the DAP 101 are backed up to the PC 1 will be described. FIG. 2 is a diagram illustrating processing operation of the content managing system 300 in a case where the playlists which are stored in the DAP 101 are backed up to the PC 1. In FIG. 2, the storage section 103 of the DAP 101 is described as “internal memory”, the memory card 104 is described as “SD card 1”, and the memory card 105 is described as “SD card 2”.

A folder for back-up and a folder for restore are made in the storage section 103 of the DAP 101. When the DAP 101 is connected to the PC 1, the mode of the DAP 101 becomes USB connection mode . In this time, the CPU 102 of the DAP 101 outputs all playlists of the music application P2 to the folder for back-up in the storage section 103 as a playlist file (1). When outputting, the CPU 102 writes an original header to the playlist file. The original header includes at least a playlist name.

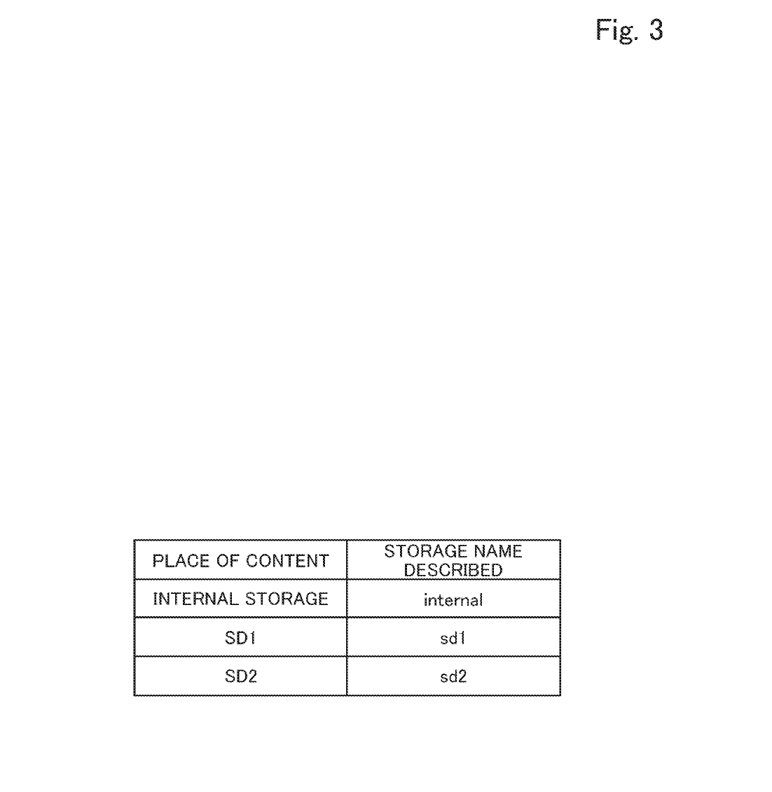

With regard to the path to content of the playlist file, a case where multi storages exist is considered (in the DAP 101, three storages of the storage section 103, and the memory cards 104 and 105 exist), and a path section to the storage is replaced as illustrated in FIG. 3 and is described as below.

file://{storage name}/dir/content.mp3

In the playlist file, paths to contents are described in line up.

file://internal/dir/content1.mp3

file://sd1/dir/content2.mp3

file://sd2/dir/content3.mp3

As described above, the CPU 102 replaces part which indicates the storage in the path of content which is included in the playlist file to a predetermined name based on the storage in which the content is stored.

The CPU 2 of the PC 1 copies the folder for back-up in the storage section 103 of the DAP 101, and stores the folder in an optional folder in the storage section 3 of the PC 1 (2). Namely, the CPU 2 stores (backs up) the playlist file exists in the folder for back-up in the storage section 103 which is included in the DAP 101 in the storage section 3.

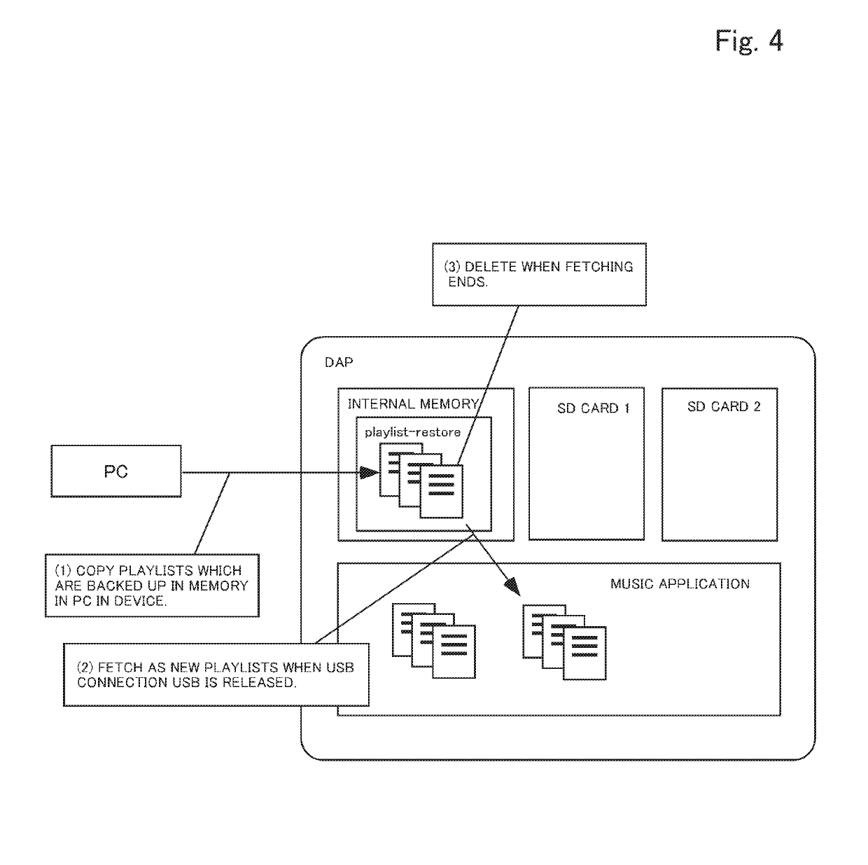

Next, processing operation of the content managing system 300 in a case where the playlists which are stored in the PC 1 are restored to the DAP 101 will be described. FIG. 4 is a diagram illustrating processing operation of the content managing system 300 in a case where the playlists which are stored in the PC 1 are restored to the DAP 101. In FIG. 4, the storage section 103 of the DAP 101 is described as “internal memory”, the memory card 104 is described as “SD card 1”, and the memory card 105 is described as “SD card 2”.

When the DAP 101 is connected to the PC 1 by USB, the CPU 2 of the PC 1 presents the playlists which are copied from the DAP 101 to the user by displaying the playlists on the display section 6 and makes the user select playlist to restore by the operation section 7. Namely, the CPU 2 displays the playlist file which is in the storage section 5 on the display section 6 and receives selection of the playlist file by the operation section 7. The CPU 2 copies the playlist file that the CPU 2 receives selection (is selected by the user) to the folder for restore which is in the storage section 103 of the DAP 101 (1).

When USB connection is released, the DAP 101 performs processing described below. When the playlist file exists in the folder for restore, the CPU 102 of the DAP 101 analyzes the playlist file and fetches the file into the music application P2 (2). In this time, the CPU 102 performs confirmation as follows. When the original header does not exist in the playlist file, the CPU 102 does not fetch the playlist file into the music application P2. The CPU 102 reads a path to content at the time of fetching according to a table illustrated in FIG. 3. Namely, the CPU 102 returns part which indicates the storage in the path of content which is included in the playlist file to the name of the storage in which the content is stored. In the playlist file, the CPU 102 does not fetch a path of column in which content does not exist into the music application P2. The CPU 102 does not make playlist with regard to the playlist file which does not include content at all. When the same name playlist as the playlist which exists in the folder for restore already exists in the music application P2, the CPU 102 overwrites the playlist and updates. Alternatively, the CPU 102 deletes the same name playlist of the music application P2 and fetches the playlist file into the music application P2. The CPU 102 can judge whether the playlist name is the same or not by a playlist name which is included in the header. The CPU 102 deletes the fetched playlist file which exists in the folder for restore.

As described above, in the present embodiment, when the PC 1 is connected to the DAP 101, the CPU 102 of the DAP 101 outputs the playlists of the music application P2 to the folder for back-up of the storage section 103 as the playlist file. Thus, the PC 1 can store (back up) the playlist file in the storage section 5 from the folder for back-up of the storage section 103. In this manner, according to the present embodiment, playlist management such as one operating uniquely in any protocol can be realized without using a dedicated protocol.

Further, in the present embodiment, the CPU 102 of the DAP 101 writes the header which includes at least a playlist name which is a name of a playlist into the playlist file. Thus, the playlist name can be grasped from the header.

Further, in the present embodiment, the CPU 102 of the DAP 101 replaces part which indicates the storage in the path of content which is included in the playlist file to a predetermined name based on the storage in which the content is stored.

Further, in the present embodiment, after the connection to the PC 1 is released, when the playlist file exists in the folder for restore, the CPU 102 of the DAP 101 fetches the playlist file into the application. Thus, playlists can be restored.

Further, in the present embodiment, the CPU 2 of the PC 1 stores the playlist that the CPU 2 receives selection in the folder for restore in the storage section 103 included in the DAP 101.

The embodiment of the present disclosure is described above, however, the mode to which the present disclosure is applicable is not limited to the above embodiment and can be suitably varied without departing from the scope of the present disclosure as exemplified below.

In the above described embodiment, as an electronic device, the DAP 101 is illustrated. Not limited to this, an electronic device may be a smartphone, a tablet or the like as long as the electronic device can make playlists.

The present disclosure can be suitably employed in a playlist managing system which manages playlists.

1. An electronic device comprising:
an internal memory which has a folder for back-up; and
a first controller, wherein
the first controller outputs playlists of an application to the folder for back-up of the internal memory as a playlist file when a playlist managing device is connected to the electronic device.

2. The electronic device according to claim 1,
wherein the first controller writes a header which includes at least a playlist name which is a name of a playlist to the playlist file.

3. The electronic device according to claim 1, further comprising:
a plurality of storages including the internal memory, and
wherein the first controller replaces part which indicates the storage in a path of content included in the playlist file to a predetermined name based on the storage in which the content is stored.

4. The electronic device according to claim 1,
wherein the internal memory further has a folder for restore, and
the first controller fetches the playlist file into the application when the playlist file exists in the folder for restore after connection to the playlist managing device is released.

5. The electronic device according to claim 4,
wherein the first controller does not fetch the playlist file into the application when the header does not exist in the playlist file.

6. The electronic device according to claim 4,
wherein the first controller returns the part which indicates the storage in the path of content which is included in the playlist file to a name of the storage in which the content is stored.

7. The electronic device according to claim 4,
wherein the first controller does not fetch a path of a column in which content does not exist in the playlist file into the application.

8. The electronic device according to claim 4,
wherein the first controller does not make playlists with regard to a playlist file which does not include contents at all.

9. The electronic device according to claim 4,
wherein the first controller overwrites and updates a playlist when the same name playlist as the playlist file which exists in the folder for restore exists in the application.

10. The electronic device according to claim 4,
wherein the first controller deletes a playlist and fetches a playlist file into the application when the same name playlist as the playlist file which exists in the folder for restore exists in the application.

11. The electronic device according to claim 4,
wherein the first controller deletes the playlist file that the controller fetches into and which exists in the folder for restore.

12. A playlist managing device comprising:
a memory; and a second controller,
wherein the second controller stores a playlist file which exists in a folder for back-up in an internal memory which is included in an electronic device to the memory at the time when the electronic device is connected.

13. The playlist managing device according to claim 12,
further comprising: a display section and an operation section, and
wherein the second controller displays the playlist file in the memory on the display section when the electronic device is connected to the playlist managing device,
receives selection of a playlist file by the operation section,
and stores the playlist of which the selection is received to a folder for restore in the internal memory which is included in the electronic device.

14. A playlist managing system comprising:
an electronic device comprising:
an internal memory which has a folder for back-up; and
a first controller, wherein
the first controller outputs playlists of an application to the folder for back-up of the internal memory as a playlist file when a playlist managing device is connected to the electronic device,
and
the playlist managing device comprising:
a memory; and a second controller,
wherein the second controller stores a playlist file which exists in the folder for back-up in then internal memory which is included in the electronic device to the memory at the time when the electronic device is connected.

15. An electronic device comprising:
circuity, wherein
the circuity outputs playlists of an application to a folder for back-up as a playlist file when a playlist managing device is connected to the electronic device.

16. A playlist managing device comprising:
circuitry,
wherein the circuitry stores a playlist file which exists in a folder for back-up in an internal memory which is included in an electronic device at the time when the electronic device is connected.
